(19) United States
(12) Patent Application Publication
(10) Pub. No.: US 2025/0368263 A1
(43) Pub. Date: Dec. 4, 2025

(54) STEERING ANGLE SENSOR DEVICE IN A STEERING SYSTEM OF A MOTOR VEHICLE AND STEERING SYSTEM

(71) Applicant: ZF Active Safety GmbH, Koblenz (DE)

(72) Inventors: Rainer ENGEL, Krefeld (DE); Heinz-Dieter HEITZER, Heinsberg (DE); Andreas DE MOLL, Kaarst (DE); Eduard SPAN, Koeln (DE)

(21) Appl. No.: 19/219,047

(22) Filed: May 27, 2025

(30) Foreign Application Priority Data
May 28, 2024 (DE) 10 2024 204 933.6

(51) Int. Cl. B62D 15/02

(52) U.S. Cl. CPC B62D 15/0225

(57) ABSTRACT

A steering angle sensor device (12) in a steering system (10) of a motor vehicle has a rotation angle sensor (34) which is connected to a gear (30) via a shaft (28) and detects a rotation of the gear (30), wherein the gear (30) is designed to mesh with a thread (20) on a steering rod (14). The steering angle sensor device (12) is designed as a pre-assembled unit with its own outer housing (24) to be mounted on a steering housing (22), in which the rotation angle sensor (34), the shaft (28) and the gear (30) are received. In the steering system (10), the outer housing (24) of the steering angle sensor device (12) can be inserted into a sensor receptacle (26) in such a way that the gear (30) meshes with the thread (20) of the steering rod (14).

### TECHNICAL FIELD

The invention relates to a steering angle sensor device in a steering system of a motor vehicle and to a steering system of a motor vehicle.

### BACKGROUND

It is known to determine the displacement of the steering rod in the steering system of a motor vehicle using a steering angle sensor, wherein these data correlate with the angular position of a conventional steering column. The steering column is conventionally connected to a pinion, which forms a rack and pinion steering gear with a rack section of the steering rod. However, steer-by-wire steering systems are increasingly being developed without a direct mechanical connection between the steering wheel and the steering rod. The steering rod is then moved via an electric servo drive, which comprises, for example, a recirculating ball drive.

### SUMMARY

The object of the invention is to provide a cost-effective and accurate detection of the position of a steering rod for such steering systems.

This object is achieved by a steering angle sensor device in a steering system of a motor vehicle, wherein the steering angle sensor device comprises a rotation angle sensor which is connected to a gear via a shaft and detects a rotation of the gear, wherein the gear is designed to mesh with a thread on a steering rod, and wherein the steering angle sensor device is designed as a preassembled unit with its own outer housing to be mounted on a steering housing, in which the rotation angle sensor, the shaft and the gear are received.

The steering angle sensor device is a standalone unit and can therefore be handled as a whole, which enables both pre-assembly production and easy handling during final assembly on a steering housing.

In a preferred variant, the outer housing forms a cartridge which is designed to be inserted into a suitable sensor receptacle of the steering housing, which simplifies a precise installation of the steering angle sensor device.

Preferably, the outer housing has a lateral opening in a threaded end section through which a toothing of the gear is accessible. The side opening allows the gear to engage with the thread of the steering rod. The engagement occurs, for example, when inserting the outer housing into the sensor receptacle of the steering housing.

The steering angle sensor device is particularly suitable for a steering system of a motor vehicle, in which the thread is a spindle thread which is part of a ball screw drive of a servo drive of the steering system, wherein the gear is attached to the steering rod in such a way that it meshes with the spindle thread. In this way, the sensor device is directly coupled to the spindle thread of the servo drive, which is used directly to operate the steering. The direct contact of the gear with the spindle thread increases the accuracy of determining the absolute position of the steering rod and thus the steering rod displacement.

If the gear meshes with the spindle thread at a 90° angle, the sensor device can be arranged on the steering rod in a space-saving manner.

The gear is preferably made of a suitable plastic in order to reduce wear of the spindle thread caused by the gear as much as possible. For example, a suitable polyoxymethylene (POM) or polyurethane can be used.

The teeth of a gear toothing can have a rounded, in particular circular, outer circumference. Since two rounded teeth engage the teeth of the steering rod at the same time, a radial offset of the center of the gear from the center of the thread, i.e. the steering rod, is necessary to ensure that the gear engages the thread without play. The radial play compensation can be achieved by pressing the gear against the steering rod, e.g. via a spring.

For example, the outer circumference can be circular with an angle>180, such as up to 270°.

A compact design of the steering angle sensor device results, for example, from the fact that the rotation angle sensor is directly connected to a shaft that also carries the gear.

In a preferred variant, the shaft comprises a sensor-side section, a thread-side section and a middle section, wherein the middle section connects the sensor-side section and the thread-side section and has a flexible element which is designed to transmit a rotational movement from the thread-side section to the sensor-side section, i.e. is torsionally rigid, and allows tilting between the thread-side section and the sensor-side section, i.e. has a certain flexibility perpendicular to the longitudinal extent of the shaft.

The middle section and thus the flexible element are placed in the longitudinal direction of the shaft between the sensor-side and the thread-side sections.

The flexible element generates, among other things, a preload and a controlled, constantly acting pressure force of the gear in the radial direction towards the thread. Thus, the flexible element and the tilting of the thread-side section of the shaft relative to the sensor-side section compensate for radial play between the gear teeth and the thread. This results in good contact between the gear and the thread, which increases the measuring accuracy of the steering angle sensor device.

For example, the sensor-side and thread-side sections of the shaft are rigid, and the bending rigidity of the entire shaft is determined by the flexible element.

The sensor-side section can act directly on the angle sensor, so that rotation of the shaft is immediately detected by the angle sensor.

In a preferred variant, the shaft is formed in one piece and the flexible element is part of the shaft.

In particular, the entire shaft is made of a suitable steel material or plastic material.

One possible design provides that the flexible element has a cylindrical body with multiple radial recesses extending from a circumferential surface, which recesses are arranged in such a way that the flexible element is torsionally rigid but can be bent in the radial direction by a predetermined amount. This counteracts the bending with a defined force and the flexible element generates a desired radial contact force through the bending.

The radial recesses extend radially inward from the circumferential surface of the cylindrical body and are preferably formed as slots running along the circumferential direction of the cylindrical body. Axially successive recesses are preferably arranged offset in the circumferential direction.

The bending rigidity of the flexible element perpendicular to the longitudinal direction of the shaft can be adjusted to a wide extent by adjusting the number, shape and extension in the radial and circumferential directions, while at the same time ensuring sufficient torsional rigidity.

This allows radial compliance to adjust the radial position of the shaft and thus of the gear.

In a possible alternative, the shaft consists of three originally separate components, wherein the flexible element is designed, for example, like a bellows and is connected in a rotationally fixed manner to the sensor-side and thread-side sections of the shaft.

Basically, the shaft is designed to be torsionally rigid so that there is no significant twisting of the thread-side section relative to the sensor-side section. In other words, the resulting twisting of the thread-side section relative to the sensor-side section of the shaft always remains so small that it is below the measuring accuracy of the rotation angle sensor.

In the outer housing, the shaft is received, for example, on the sensor side in a first bearing and on the thread side in a second bearing, wherein the first bearing holds the shaft in a fixed position with respect to the outer housing and the second bearing is designed to provide a predetermined radial movement range for the shaft with respect to the outer housing. The second bearing thus allows a certain radial movement of the gear relative to the thread and the adjustment of the radial position of the gear due to the flexibility of the shaft. For example, a play of up to 1 mm, in particular up to 0.7 mm, can be compensated.

The first bearing normally accommodates the sensor-side section of the shaft and the second bearing the thread-side section of the shaft, so that the two bearings are arranged on either side of the flexible element with respect to the longitudinal extent of the shaft.

The second bearing is preferably positioned in an end region of the thread-side section of the shaft at the greatest possible distance from the flexible element in order to allow the greatest possible range of movement for the gear in the radial direction.

In order to realize the radial movement range for the shaft, in one possible variant the second bearing is received in a receptacle in the outer housing designed as an elongated hole, in which the second bearing can move by a predetermined play in the radial direction with respect to the thread. Accordingly, the elongated hole should be aligned radially with respect to the shaft and the thread. The thread-side section of the shaft can then be received in the second bearing without any play, which simplifies the design of the second bearing.

The second bearing is designed, for example, as a rolling bearing in which the inner ring accommodates the thread-side section of the shaft without play and the outer ring is held in the receptacle in the outer housing so that it can be moved in the radial direction with play.

Preferably, the receptacle of the second bearing is not elastic. For example, the movement of the second bearing relative to the receptacle occurs only through the flexible element of the shaft.

In addition to the flexible element, a spring pin which is elastically flexible in the radial direction of the shaft could also be provided, which pin acts on the second bearing, in particular its outer ring, and loads the second bearing in the direction of the thread.

With this design, the receptacle can be easily manufactured as a single piece with the outer housing, for example as a recess in the outer housing. For example, the receptacle of the second bearing can merge axially into the lateral opening of the outer housing through which the gear is accessible. The receptacle of the second bearing can be arranged in particular at the thread-side axial end of the outer housing, so that the outer housing is axially open at this point.

The above-mentioned object is also achieved with a steering system of a motor vehicle with a steering angle sensor device as described above, which has a steering housing which comprises a sensor receptacle into which the outer housing of the steering angle sensor device can be inserted such that the gear meshes with the thread of the steering rod, in particular at a 90° angle to the steering rod.

The thread is preferably a spindle thread which is part of a ball screw drive of a servo drive of the steering system, and the teeth of the gear wheel have a rounded, in particular circular arc-shaped, outer circumference which is adapted to a cross-section of a ball track of the ball screw drive. For example, the outer shape of the teeth of the gear can correspond to the cross-section of the ball tracks. The rounded outer circumference preferably extends over more than 180°, for example up to 270°, so that at any time at least one of the teeth of the gear can be brought into contact with the thread of the steering rod without play by permanently pressing the gear against the steering rod. It has been found that, for example, up to a radial offset of 0.7 mm or even up to 1 mm, a decent contact between the toothing and the thread and thus an essentially play-free engagement of the gear in the thread can be achieved.

### BRIEF DESCRIPTION OF THE DRAWINGS

In the following, the invention will be described in more detail by way of a plurality of exemplary embodiments, with reference to the accompanying figures. In the figures:

FIG. 1 is a schematic sectional view of a steering system of a vehicle according to the invention with a steering angle sensor device according to the invention

FIG. 2 is a schematic perspective view of the steering angle sensor device of FIG. 1;

FIG. 3 is a schematic sectional view of the steering angle sensor device of FIG. 1 according to a first variant;

FIGS. 4 to 6 are schematic representations of the assembly of a shaft of the steering angle sensor device from FIG. 2 in an outer housing;

FIG. 7 is a schematic sectional view of the steering angle sensor device of FIG. 1 according to a second variant;

FIG. 8 is a schematic perspective view of a gear of the steering angle sensor device of FIG. 1;

FIGS. 9 and 10 are schematic representations of the engagement of a toothing of the gear from FIG. 8 in a thread of a steering rod;

FIGS. 11 and 12 are schematic representations of a bearing of the shaft of the steering angle sensor device from FIG. 1;

FIGS. 13 to 15 are schematic exploded views of the steering system and the steering angle sensor device of FIG. 1; and

FIGS. 16 to 18 are different schematic perspective views of the steering system from FIG. 1 with a steering angle sensor device inserted into a sensor receptacle.

### DESCRIPTION

For reasons of clarity, not all identical components are always provided with reference symbols. The same reference symbols (as well as numbers increased by 100) designate identical or substantially identical or equivalent components and parts in different embodiments.

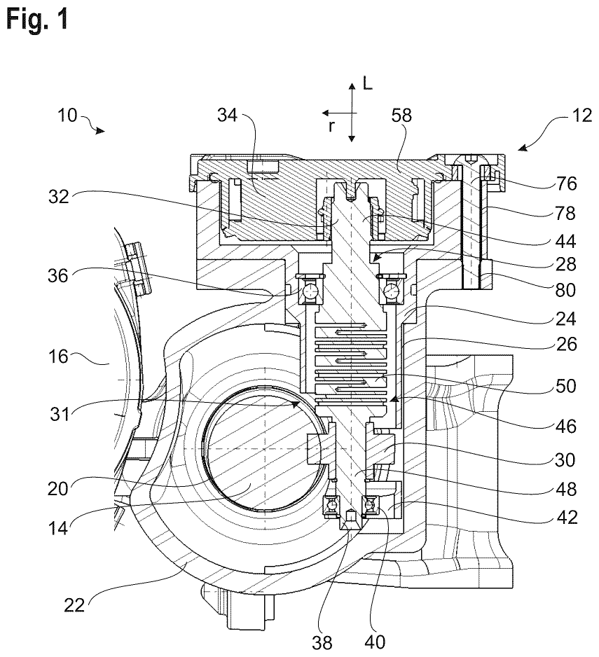

FIG. 1 shows a steering system 10 of a motor vehicle with a steering angle sensor device 12.

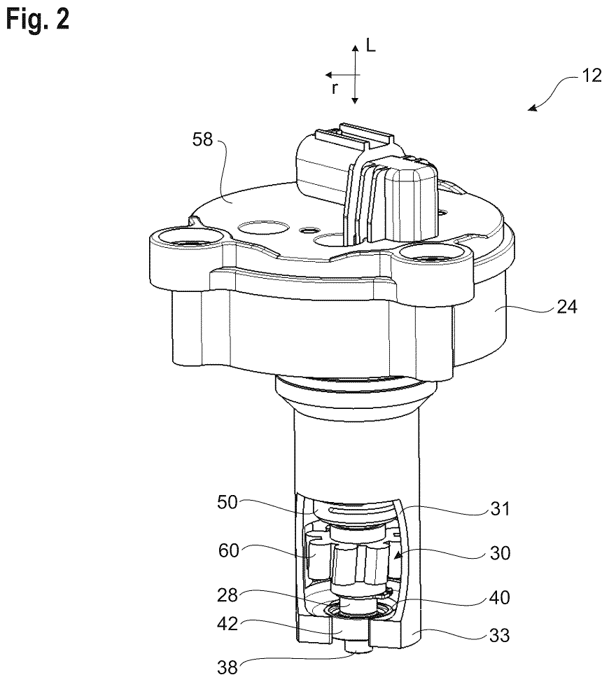

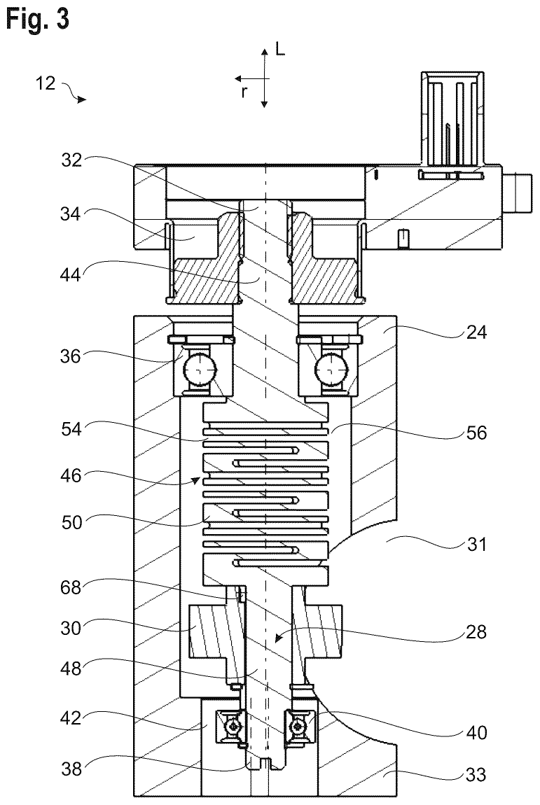

FIG. 2 shows the steering angle sensor device 12 in a perspective view and FIG. 3 in a sectional view.

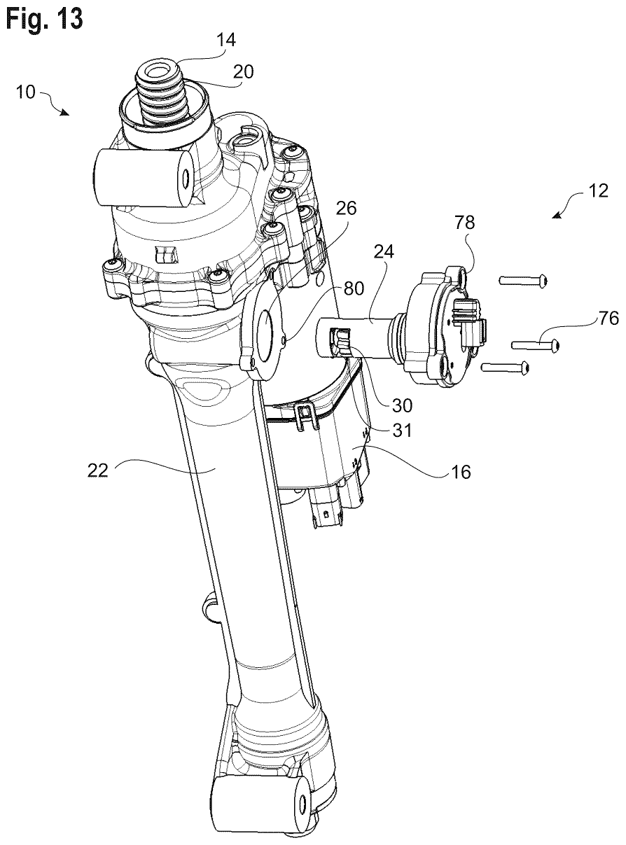

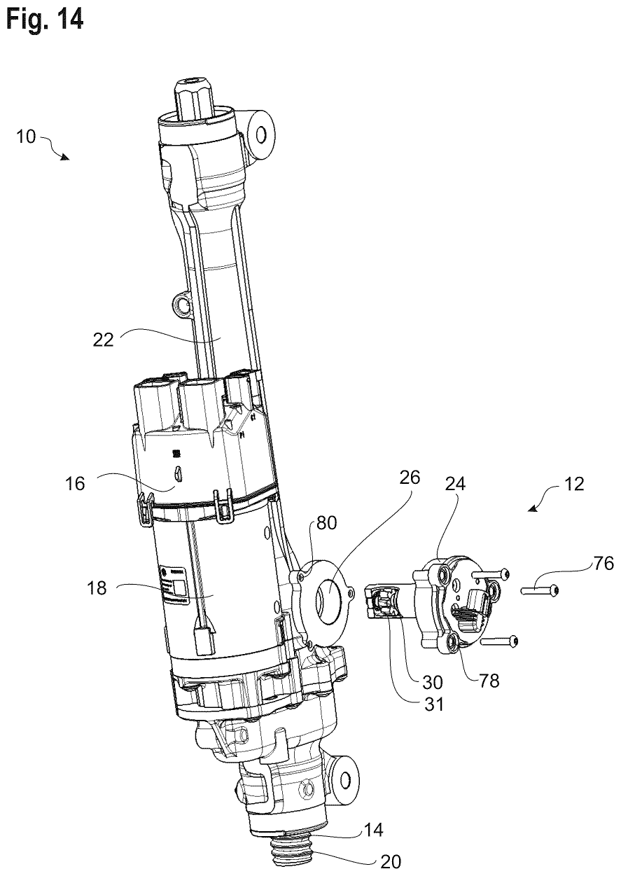

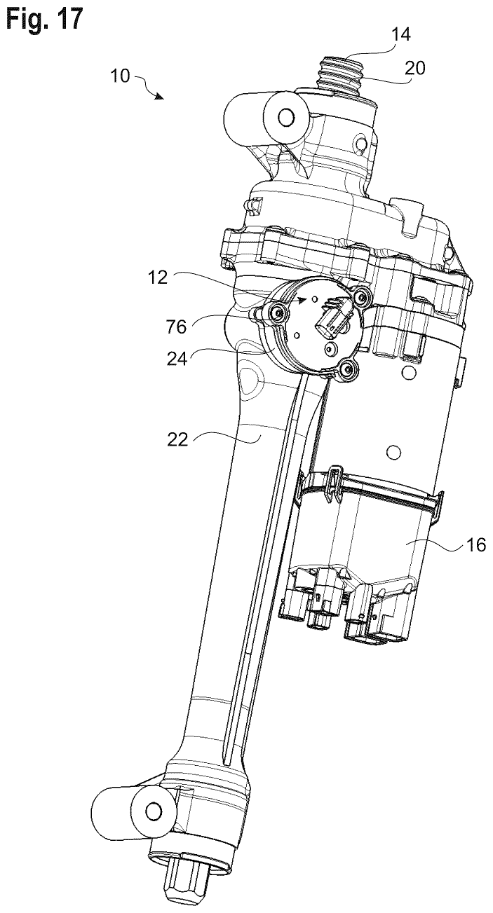

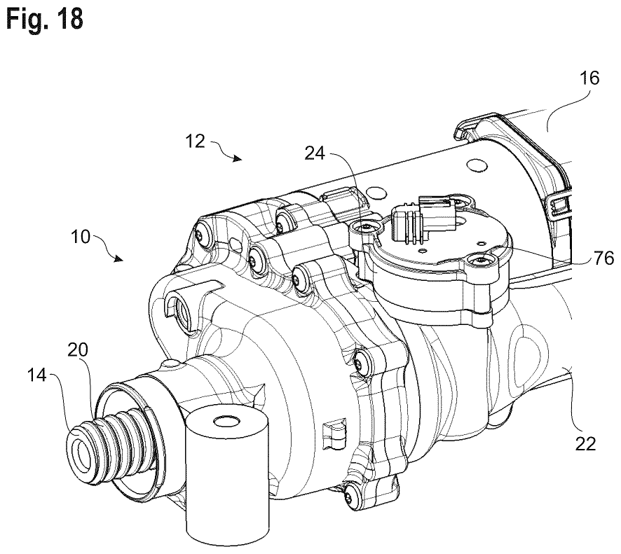

The steering angle sensor device 12 detects a movement of a steering rod 14 which is moved by an electric servo drive 16 acting on the steering rod 14 (see, for example, FIGS. 13 to 18).

The steering movement of the vehicle is achieved purely by controlling the electric motor of the servo drive 16 (steer-by-wire). The servo drive 16 comprises a known ball screw drive 18 (not shown in detail) which can move the steering rod 14 linearly depending on the desired steering rod displacement path. The ball screw drive 18 comprises a thread 20 in the form of a spindle thread on the steering rod 14, via which a nut of the ball screw drive 18 acts on the steering rod 14.

The steering rod 14 is secured in a suitable manner against twisting and can therefore only move linearly.

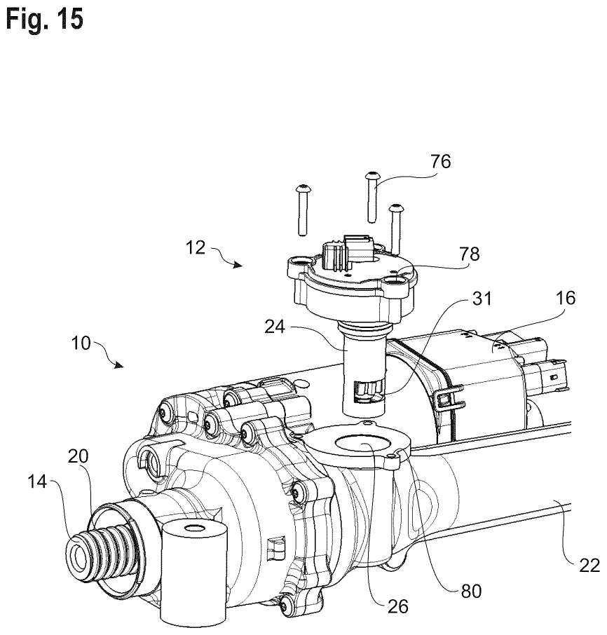

The servo drive 16, the ball screw drive 18 (see FIGS. 14 and 15) and the steering rod 14 are received together in a steering housing 22.

The current position of the steering rod 14, which correlates with the current steering angle of the steering, is detected by the steering angle sensor device 12.

The steering angle sensor device 12 has its own outer housing 24 separate from the steering housing 22 and forms a prefabricated cartridge (see e.g. FIGS. 2, 13, 14 and 15).

The outer housing 24 is inserted into a matching sensor receptacle 26 formed in the steering housing 22.

In the outer housing 24 of the steering angle sensor device 12, a shaft 28 is received, on which a gear 30 is arranged in a rotationally fixed manner.

A lateral opening 31 in a thread-side end portion 33 of the outer housing 24 enables engagement of the gear 30 in the thread 20 of the steering rod 14. The gear 30 meshes with the thread 20 of the steering rod 14 and, in this example, is arranged at a 90° angle to the steering rod 14. A displacement movement of the steering rod 14 is thus directly converted into a rotation of the gear 30 and the shaft 28 firmly connected thereto.

At a first axial end 32, relative to a longitudinal extension L of the shaft 28, the shaft 28 is coupled to a rotation angle sensor 34, which detects a rotation of the shaft 28 and thus determines data for determining the current absolute steering angle of the steering system 10.

The data determined by the rotation angle sensor 34 are transmitted via a line (not shown) to a suitable control unit (not shown) of the steering system 10.

Adjacent to the first axial end 32, the shaft 28 is mounted in a first bearing 36 in the outer housing 24, essentially free of play.

At the opposite second axial end 38, the shaft 28 is received in a second bearing 40 which is displaceable in the radial direction r by a predetermined amount.

The second bearing 40 is arranged here in a receptacle 42 formed in the outer housing 24, which axially merges into the lateral opening 31, wherein the outer housing 24 is also axially open on the side opposite the receptacle 42.

The shaft 28 is in this case designed in three parts. The first axial end 32 on the rotation angle sensor side is located on a sensor-side section 44 which is connected in the longitudinal direction L to a middle section 46, to which in turn a thread-side section 48 is connected in the longitudinal direction L. The first bearing 36 is located on the sensor-side section 44 and the second bearing 40 on the thread-side section 48. The gear 30 is arranged on the thread-side section 48 between the middle section 46 and the second bearing 40. The thread-side section 48 ends in the second axial end 38.

The middle section 46 comprises a flexible element 50 which is designed to connect the sensor-side section 44 and the thread-side section 48 in a torsionally rigid manner, but is bendable perpendicular to the longitudinal extent L. Thus, the flexible element 50 allows a tilting by a small angle between the sensor-side section 44 and the thread-side section 48 of the shaft 28, but transmits a rotational movement of the thread-side section 48 to the sensor-side section 44 without delay and without distortion, so that the flexible element 50 is not noticeable within the scope of the measuring accuracy when detecting the rotation of the gear 30 by the rotation angle sensor 34.

In a first variant, which is shown in FIGS. 1 to 6, the shaft 28 is a one-piece component, here made of a suitable steel material or plastic.

The flexible element 50 has a cylindrical body 52 in which multiple recesses 54 are formed which are offset along a circumferential direction U and successive in the longitudinal direction L and extend inwards in the radial direction r. The recesses 54 here have the shape of thin, parallel slots and extend from a circumferential surface 56 of the cylindrical body 52.

The extension in the circumferential direction U is here respectively between 90° and 270°, and successive recesses 54 are respectively offset from one another by, for example, 90 to 180°. This means that the recesses 54 are arranged in pairs at 90° and 270° and then at 0° and 180°. In this way, the cylindrical body 52 forms a contiguous component which is sufficiently torsionally rigid, but which allows bending perpendicular to the longitudinal extent L through the recesses 54.

The number, size and shape of the recesses 54 are selected such that the torsional rigidity of the shaft 28 is sufficiently high, while a low bending rigidity of the entire shaft 28 results, which can compensate for a radial play of approximately 0.5 mm to 1 mm, in particular 0.7 mm, in the region of the gear 30, for example.

The second bearing 40 is mounted in the receptacle 42 in such a way that it can follow this compensating movement.

The flexible element 50 generates a restoring force perpendicular to the longitudinal extension L, which acts on the gear 30 and keeps it in the best possible contact with the thread 20.

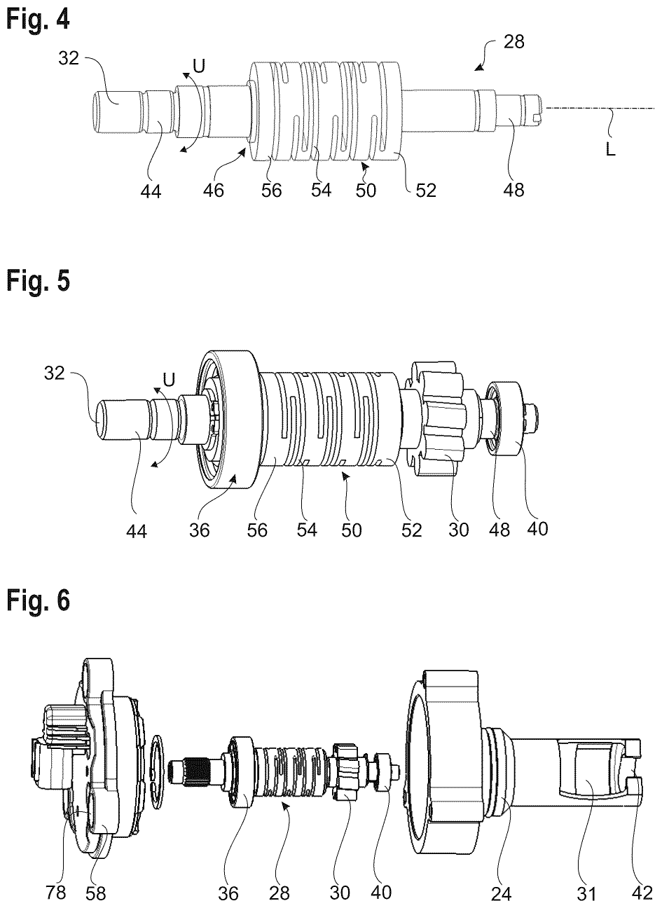

The gear 30 is here a separate component from the shaft 28, which, like the bearings 36, 40, is mounted on the shaft 28 before this is inserted into the outer housing 24 (see FIGS. 5 and 6).

Finally, a cover part 58 containing the rotation angle sensor 34 is inserted into the outer housing 24 and secured thereto, which closes the outer housing 24. The shaft 28 is held in its desired position by the bearing 36 in the outer housing 24 (see FIG. 6).

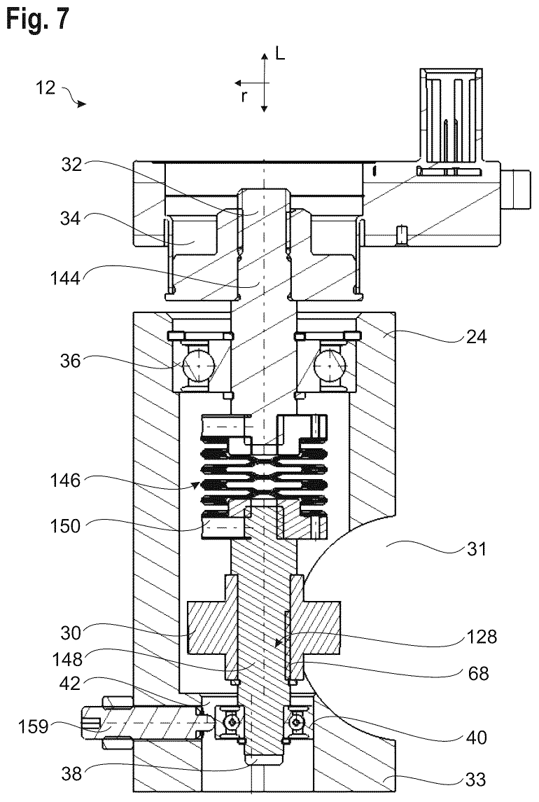

FIG. 7 shows a second embodiment of the shaft 128, in which the sections 144, 146, 148 of the shaft initially form three separate components which are assembled along the longitudinal extent L of the shaft 128. The flexible element 150 is here a bellows-like component which, as in the first embodiment described above, is sufficiently torsionally rigid, but at the same time is deformable to a certain extent perpendicular to the longitudinal extent L in order to enable the desired tilting between the sensor-side section 144 and the thread-side section 148 to compensate for radial play of the gear 30.

The second bearing 40 is preloaded radially here in the direction of the steering rod 14 by a spring element 159 (here a spring pin) which is arranged in a matching radial recess in the outer housing 24 and projects into the receptacle 42 of the second bearing 40. Such a spring element 159 could also be used in the first embodiment described above, regardless of the design of the flexible element 50, 150.

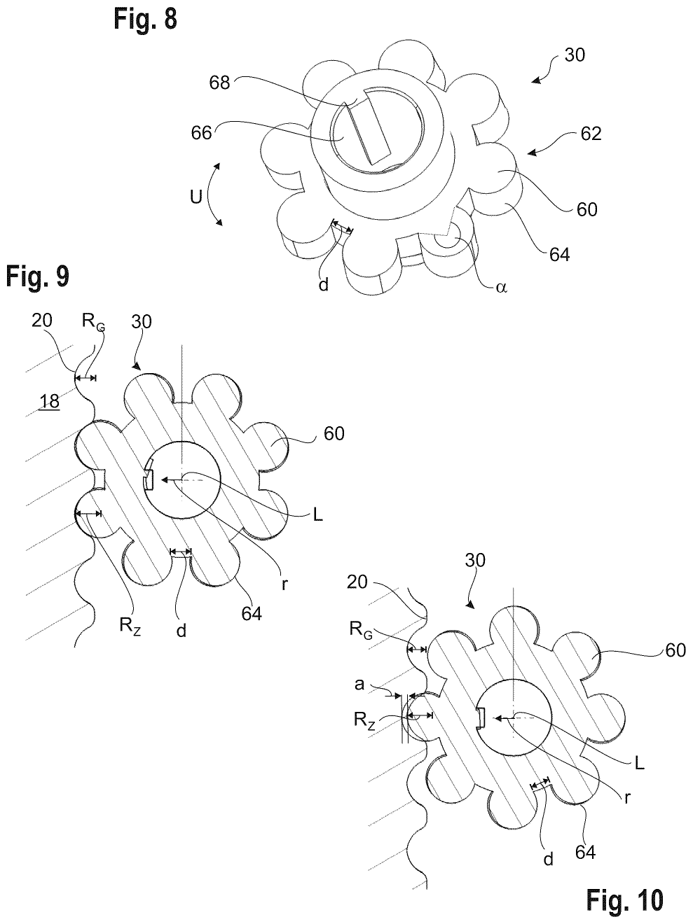

FIGS. 8 to 10 show a possible embodiment of the gear 30. The teeth 60 of a toothing 62 of the gear 30 here have a rounded outer circumference 64. In this example, the outer circumference is in the form of a circular arc and encloses an angle a greater than 180°, for example up to about 270°.

The radius R_{Z} of the outer circumference 64 is matched to a radius R_{G} of the thread 20, more specifically to the radius of a ball track of the ball screw drive 18, and in particular is selected to be approximately the same.

As FIGS. 9 and 10 illustrate, a permanent, play-free contact between the thread of the steering rod and the gear requires a certain flexibility of the bearing of the gear in the radial direction of the gear perpendicular to the longitudinal axis of the steering rod. The radial offset a to be compensated by the flexibility of the bearing is, for example, up to 0.7 mm or up to 1 mm.

The shape of the outer circumference 64 of the teeth 60 requires a distance d in the circumferential direction U between adjacent teeth 60, which must be selected adequately to allow the gear 30 to roll along the thread 20. Here, the distance d is selected so that two adjacent teeth 60 can simultaneously engage in adjacent threads of the thread 20 (see FIG. 9).

Of course, the gear 30 can also have another suitable toothing.

The gear 30 has a central opening 66 for the shaft 28, on the inner circumference of which a radially projecting web is formed as an anti-rotation device 68. The web engages in a corresponding radial recess on the shaft 28, so that the gear 30 is held on the shaft 28 without play in the circumferential direction (see, for example, FIG. 7).

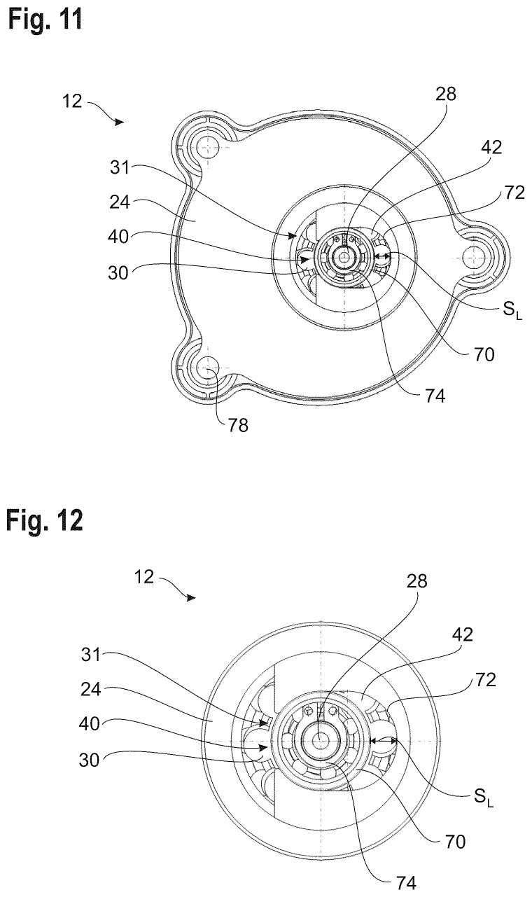

FIGS. 11 and 12 show the receptacle 42 of the second bearing 40 in more detail. FIG. 11 shows a view from the bottom of the steering angle sensor device 12, while FIG. 12 shows an enlarged section.

The receptacle 42 is designed in the form of an elongated hole which is open towards the steering rod 14. The second bearing 40 is here a rolling bearing. An outer ring 70 of the second bearing rests against an inner side 72 of the receptacle 42, and an inner ring 74 is connected in a rotationally fixed manner to the thread-side section 48 of the shaft 28. The second bearing 40 can move in the radial direction r away from the steering rod 14 within the receptacle 42 by a predetermined play S_{L} by the outer ring 70 moving in the receptacle 42.

Upon such a displacement of the second bearing 40, the flexible element 50 of the shaft 28 generates an elastic counter-force which acts on the second bearing 40 and the gear 30 in the direction of the thread 20 of the steering rod 14 and thus counteracts the displacement of the second bearing 40.

The receptacle 42 is designed here such that the shaft 28, together with the second bearing 40 already placed thereon, can be pushed into the outer housing 24 until the second bearing 40 is received in the receptacle 42.

The flexibility of the shaft 28 is also utilized in this example to establish the engagement of the gear 30 with the thread 20 by pressing the threaded portion 48 of the shaft 28 and the second bearing 40 in the receptacle 42 away from the steering rod 14 until the engagement is established. Subsequently, the pressure force exerted by the flexible element 50 constantly acts on the second bearing 40 in the receptacle 42 in the direction of the steering rod 14.

FIGS. 13 to 15 show how the prefabricated steering angle sensor device 12 is inserted into the sensor receptacle 26 of the steering housing 22. For this purpose, the outer housing 24 is inserted into the sensor receptacle 26 in such a way that the gear 30 engages and meshes with the thread 20 of the steering rod 14. In this position, the outer housing 24 of the steering angle sensor device 12 is fixed to the steering housing 22, here by means of multiple fastening screws 76.

The fastening screws 76 each pass through a fastening opening 78 on the edge of the outer housing 24 and engage in a thread of a fixing opening 80 on the edge of the sensor receptacle 26. This simultaneously provides an anti-rotation device for the outer housing 24 with respect to the steering housing 22 and defines a correct mounting position.

The sensor receptacle 26 extends at a 90° angle to the steering rod 14, so that the axis of rotation of the gear 30, which coincides with the longitudinal extension L of the shaft 28, is perpendicular to the axis of the steering rod 14.

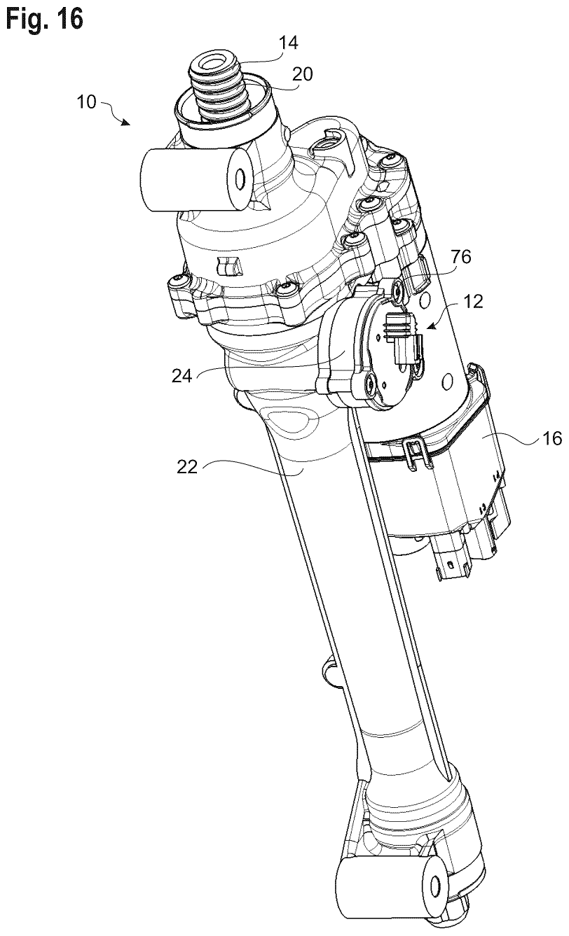

FIGS. 16 to 18 show the fully mounted assembly of steering housing 22 and steering angle sensor device 12 of the steering system 10. In this example, the sensor receptacle 26 is located in the immediate vicinity of a fastening flange of the servo drive 16 on the steering housing 22.

All features of the individual variants can be freely exchanged or combined with one another at the discretion of the skilled in the art. In particular, an outer housing 24 designed as a cartridge, the design of the shaft 28 with a flexible element 50, the shape of the teeth 60 of the gear 30 or the displaceable design of the second bearing 40, optionally using a spring element 159, can be combined with one another as desired and can also be implemented independently of one another in a steering angle sensor device 12.

1. A steering angle sensor device (12) in a steering system (10) of a motor vehicle, comprising a rotation angle sensor (34) which is connected to a gear (30) via a shaft (28; 128) and detects a rotation of the gear (30), wherein the gear (30) is designed to mesh with a thread (20) on a steering rod (14), and wherein the steering angle sensor device (12) is designed as a preassembled unit with its own outer housing (24) to be mounted on a steering housing (22), in which outer housing the rotation angle sensor (34), the shaft (28; 128) and the gear (30) are received.

2. The steering angle sensor device (12) according to claim 1, wherein the outer housing (24) forms a cartridge which is designed to be inserted into a matching sensor receptacle (26) of the steering housing (22).

3. The steering angle sensor device (12) according to claim 1, wherein the outer housing (24) has a lateral opening (31) in a thread-side end portion (33) through which a toothing (62) of the gear (30) is accessible.

4. The steering angle sensor device (12) according to claim 1, wherein the thread (20) is a spindle thread which is part of a ball screw drive (18) of a servo drive (16) of the steering system (10).

5. The steering angle sensor device (12) according to claim 4, wherein teeth (60) of a toothing (62) of the gear (30) have a rounded, in particular circular-arc-shaped, outer circumference (64).

6. The steering angle sensor device (12) according to claim 1, wherein the shaft (28; 128) has a sensor-side section (44; 144), a thread-side section (48; 148) and a middle section (46; 146), wherein the middle section (46; 146) connects the sensor-side section (44; 144) and the thread-side section (48; 148) and has a flexible element (50; 152) which is designed to transmit a rotational movement from the thread-side section (48; 148) to the sensor-side section (44; 144) and to allow tilting between the thread-side section (48; 148) and the sensor-side section (44; 144).

7. The steering angle sensor device (12) according to claim 6, wherein the shaft (28) is formed in one piece and the flexible element (50) is part of the shaft (28).

8. The steering angle sensor device (12) according to claim 7, wherein the flexible element (50) has a cylindrical body (52) with multiple radial recesses (54) extending from a circumferential surface (56), which recesses are arranged such that the flexible element (50) is torsionally rigid but can be bent in the radial direction (r) by a predetermined amount.

9. The steering angle sensor device (12) according to claim 1, wherein the shaft (28; 128) is received on the sensor side in a first bearing (36) and on the thread side in a second bearing (40), wherein the first bearing (36) holds the shaft (28; 128) in a fixed position with respect to the outer housing (24) and the second bearing (40) is designed such that it offers a predetermined radial movement range for the shaft (28; 128) with respect to the outer housing (24).

10. The steering angle sensor device (12) according to claim 9, wherein the second bearing (40) is received in a receptacle (42) of the outer housing (24) designed as an elongated hole, in which the second bearing (40) can be displaced by a predetermined play (S_{L}) in the radial direction (r) with respect to the thread (20).

11. A steering system (10) of a motor vehicle, comprising a steering angle sensor device (12) according to claim 1, and comprising a steering housing (22) which comprises a sensor receptacle (26) into which the outer housing (24) of the steering angle sensor device (12) can be inserted such that the gear (30) meshes with the thread (20) of the steering rod (14).

12. The steering system (10) according to claim 11, wherein the thread (20) is a spindle thread which is part of a ball screw drive (18) of a servo drive (16) of the steering system (10) and the teeth (60) of a toothing (62) of the gear (30) have a rounded, in particular circular-arc-shaped, outer circumference (64) which is adapted to a cross section of a ball track of the ball screw drive (18).
